(19) United States
(12) Patent Application Publication
(10) Pub. No.: US 2023/0349832 A1
(43) Pub. Date: Nov. 2, 2023

(54) HIGH SPECTRAL AND TEMPORAL RESOLUTION GLOW DISCHARGE SPECTROMETRY DEVICE AND METHOD

(71) Applicant: HORIBA FRANCE SAS, Palaiseau (FR)

(72) Inventor: Patrick CHAPON, Villebon Sur Yvette (FR)

(21) Appl. No.: 18/308,138

(22) Filed: Apr. 27, 2023

(30) Foreign Application Priority Data
Apr. 29, 2022 (FR) 2204104

(51) Int. Cl. G01N 21/68; G01B 11/22; G01N 21/67

(52) U.S. Cl. CPC G01N 21/68; G01B 11/22; G01N 21/67; G01N 2201/0634; G01N 2201/0635

(57) ABSTRACT

Disclosed is a glow discharge spectrometry device including a glow discharge lamp and an optical emission spectrometer adapted to receive a light beam emitted by a glow discharge plasma. The optical emission spectrometer includes a dispersive optical component and an echelle grating arranged and configured in such a way as to form a two-dimensional spectrum of the light beam, the two-dimensional spectrum being dispersed in a plurality of diffraction orders, the plurality of diffraction orders extending along a first direction and each diffraction order extending spectrally according to a second direction transverse to the first direction and a pixel-array CMOS sensor arranged and configured to acquire the two-dimensional spectrum as a function of time.

This application claims the priority under 35 USC 119(a) of French patent application 2204104 filed on Apr. 29, 2022, the entirety of which is incorporated herein by reference.

### TECHNICAL FIELD

The present invention relates to devices and methods for analyzing solid samples by glow discharge spectrometry.

### PRIOR ART

Glow discharge spectrometry (GDS) is a technique of analysis that allows measuring the elementary and/or molecular chemical composition of homogeneous or multilayer solid samples. The measurement may be done in the bulk or be depth-resolved. Moreover, distinction is made between the glow discharge devices or sources that analyze solid samples using mass spectrometry (GD-MS, for glow discharge mass spectrometry) or those which make it using optical emission spectrometry (GD-OES, for glow discharge optical emission spectrometry).

The principle of glow discharge spectrometry consists in eroding a surface of a sample using plasma, then exciting and/or ionizing the eroded chemical species and detecting the ionized species by mass spectrometry, or respectively the excited species by optical emission spectrometry, to deduce therefrom the sample composition. A gas, also called plasma gas, is injected into the vacuum chamber of a discharge lamp and electrical power is applied between the electrodes of the lamp to generate a plasma. The plasma gas is generally an inert gas such as argon, neon, krypton or helium. The plasma gas may also be formed of a mixture of gas, for example a mixture of argon and another gas such as oxygen, hydrogen, nitrogen or helium. The surface of the sample placed in the vacuum enclosure of the lamp is thus exposed to an ablation plasma. This plasma ensures both erosion of the solid material to be analyzed and excitation and/or ionization of the eroded spaces in gaseous phase. A mass spectrometer or an optical emission spectrometer, coupled to the vacuum enclosure, allows analyzing the chemical species present in the plasma. As a function of the erosion duration, GDS allows a depth-resolved quantitative analysis of certain samples, thus providing a composition profile of the analyzed sample.

GDS is relatively simple to use and has varied applications. It allows analysis of minor or major trace elements in metallic or non-metallic solid samples. Glow discharge spectrometry (GDS) allows analyzing the chemical composition of solid materials in the bulk but also as a function of the depth (depth profile). The ability to obtain depth profiles is clearly what distinguishes GDS from other elementary analysis techniques such as spark spectrometry, Laser Induced Breakdown Spectroscopy (LIBS) or also X-ray fluorescence.

Optical mounts used in GDS devices of the market are generally based on the use of a polychromator in Paschen-Runge mounting associated with photomultiplier (PM) sensors to acquire the signal at several wavelengths and/or with a series of CCD sensors arranged so as to each acquire a part of the spectrum.

However, the intensity of GDS signals is far lower than LIBS ones. To perform GDS profile measurements with a high depth spatial resolution, it is necessary to use PM sensors that allow obtaining both high sensitivity and high acquisition speed. However, the PM sensors are fixed and do not allow acquisition over the whole spectrum but only at a few predetermined wavelengths.

For applications in profile measurement of thin-layer samples, it is desirable to have a GDS device exhibiting a high temporal resolution while making it possible to acquire a greater number of wavelengths than a polychromator GDS device with PMs.

Certain samples have an unknown composition. Determining the wavelengths at which positioning the PMs then requires a preliminary study. It is hence desirable to acquire optical emission spectra over the most extended possible spectral range and with a high spectral resolution, so as to be able to detect all the chemical species in the sample composition, without knowing them in advance.

### DISCLOSURE OF THE INVENTION

For that purpose, the invention relates to a glow discharge spectrometry device comprising a glow discharge lamp adapted to form a glow discharge plasma and an optical emission spectrometer adapted to receive part of a light beam emitted by the glow discharge plasma.

According to the invention, the optical emission spectrometer comprises a dispersive optical component and an echelle grating arranged and configured in such a way as to form a two-dimensional spectrum of the light beam, the two-dimensional spectrum being dispersed in a plurality of diffraction orders (P1, . . . Pj, . . . PT), the plurality of diffraction orders (P1, . . . Pj, . . . PT) extending along a first direction (X) and each diffraction order (P1, . . . Pj, . . . PT) extending spectrally according to a second direction (Y) transverse to the first direction (X), and a pixel-array CMOS sensor arranged and configured to acquire the two-dimensional spectrum as a function of time.

According to a particular and advantageous aspect, the CMOS sensor is adapted to acquire at least 20 frames (images) per second, for example 30, 50 or even 100 frames per second.

In an embodiment, the CMOS sensor comprises N rows of M pixels, where N is higher than or equal to 512 and M is higher than or equal to 512, for example 1024×1024 pixels or preferably 2048×2048 pixels.

According to another particular and advantageous aspect, each diffraction order (P1, . . . Pj, . . . PT) extends along a row of the CMOS sensor.

Advantageously, the glow discharge spectrometry device comprises a data processing system configured to process the CMOS sensor signals on a macropixel basis, each macropixel comprising at least 2×2 adjacent pixels of the CMOS sensor.

In an exemplary embodiment, the glow discharge spectrometry device comprises an optical coupling system between the glow discharge lamp and an input of the optical emission spectrometer.

According to a particular and advantageous aspect, the dispersive optical component comprises a prism.

According to a particular embodiment, the glow discharge spectrometry device comprises a monochromator or a polychromator adapted to receive another part of the light beam emitted by the glow discharge plasma, the monochromator, respectively the polychromator, comprising a diffraction grating and a photomultiplier sensor, respectively several photomultiplier sensors, each photomultiplier sensor being adapted to detect an optical emission at a determined wavelength.

Optionally, the glow discharge spectrometry device comprises a differential interferometer to measure an etching depth of an erosion crater in a sample exposed to the glow discharge plasma.

The invention also relates to a glow discharge spectrometry method comprising the following steps: forming a glow discharge plasma; receiving part of a light beam emitted by the glow discharge plasma at an input of an optical emission spectrometer; spectrally dispersing the part of the light beam over an echelle grating and a dispersive optical component to form a two-dimensional spectrum, the two-dimensional spectrum being dispersed into a plurality of diffraction orders (P1, . . . Pj, . . . PT), the plurality of diffraction orders (P1, . . . Pj, . . . PT) extending along a first direction (X) and each diffraction order (P1, . . . Pj, . . . PT) extending spectrally along a direction transverse to the first direction; and acquiring the two-dimensional spectrum on a pixel-array CMOS sensor as a function of time.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 is a schematic view of a glow discharge spectrometry device according to the invention,

FIG. 2 is a schematic view of a two-dimensional spectrum on a CMOS sensor,

FIG. 3 is a schematic view of an optical system for simultaneous coupling to an echelle spectrometer and to a polychromator equipped with photomultipliers according to a particular embodiment.

It is to be noted that, in these figures, the structural and/or functional elements common to the different alternatives may have the same references.

### DETAILED DESCRIPTION

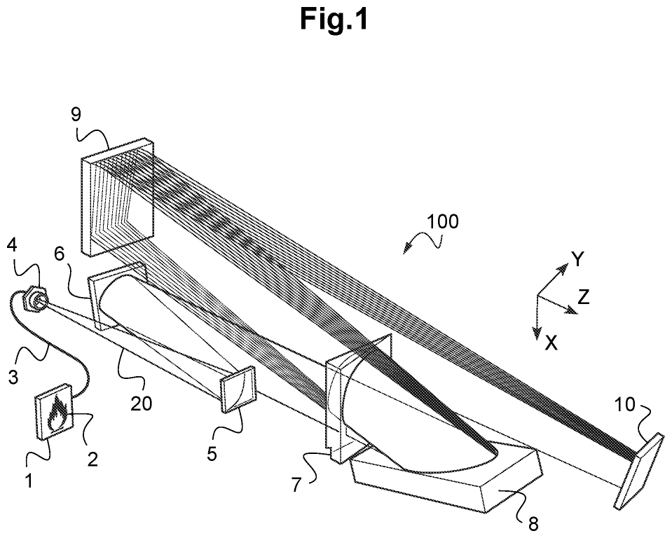

In FIG. 1, a glow discharge lamp 1 configured to form a glow discharge plasma 2 is schematically shown. As known in GDS, the glow discharge plasma is used to erode the surface of a sample that is desired to be analyzed.

The glow discharge plasma 2 generates an optical emission. Part of the light beam 20 emitted by the plasma 2 is collected, for example, via an optical fiber 3. The optical fiber 3 allows the emission light beam 20 to be guided to the input 4 of an optical emission spectrometer.

In the case where an optical fiber 3 is used to transport the light beam 20 to the spectrometer input 4, this input 4 is formed by the core of the optical fiber. As an alternative, the spectrometer input 4 comprises an elongated slit.

The optical emission spectrometer is here an echelle spectrometer combined with a pixel-array CMOS sensor 10. The echelle spectrometer comprises a combination of a dispersive optical element and an echelle grating mounted in such a way as to spectrally disperse the light beam along two transverse directions. Advantageously, the dispersive optical element is a prism mounted transversely to the echelle grating. As an alternative, the dispersive optical element comprises another diffraction grating.

Contrary to conventional systems, the echelle spectrometer is not associated with a CCD-type image sensor, but with a CMOS-type image sensor. For example, the CMOS image sensor comprises a CMOS camera. The CMOS camera technology makes it possible to acquire 2D spectra in a row at a far higher speed than with a CCD camera having the same number of pixels. In practice, image acquisition with a 2048×2048-pixel CCD sensor takes about 4 seconds, whereas image acquisition with a CMOS sensor having the same number of pixels is almost instantaneous, of the order of 20 ms. However, CMOS sensors have a far lower sensitivity than CCD sensors, which are themselves far less sensitive than photomultiplier (PM) sensors. Moreover, CMOS sensors have a dynamic range far lower than that of PM sensors or CCD sensors. Finally, CMOS sensors have a high cost compared to CCD sensors.

In the example illustrated in FIG. 1, the echelle spectrometer comprises a first mirror 5, a second mirror 6, a prism 7, an echelle grating 8 and a last mirror 9. More precisely, the echelle spectrometer is mounted in a tetrahedral configuration. The first mirror 5 and the second mirror 6 receive the light beam 20 coming from the input 4 and form a collimated beam directed towards the prism 7. As known, the prism 7 spectrally disperses the light beam in a direction transverse to the prism edge. The light beam dispersed a first time by the prism is incident on the echelle grating 8. The echelle grating 8 is a grating comprising a set of parallel lines. The echelle grating 8 receives the light beam dispersed a first time by the prism 7. The echelle grating 8 is directed in such a way that the grating lines direction is perpendicular to the edge of the prism 7. The echelle grating 8 thus diffracts the light beam in a direction transverse to that of the prism. The echelle grating 8 separates the light beam into many diffraction orders P₁, . . . Pⱼ, . . . P_{T} where T is an integer between 2 and 100, for example T is equal to 30.

The echelle grating 8 is a metallic grating, that operates in reflection. Advantageously, the echelle grating 8 is a blazed grating in autocollimation mounting. In this configuration, the angle of incidence on the echelle grating is equal to the angle of diffraction. That way, the beam diffracted by the echelle grating passes again through the prism 7 to be dispersed a second time. This double passage through the prism 7 provides a greater spectral dispersion in each diffraction order.

The last mirror 9 receives the beam spectrally dispersed along two transverse directions and forms a spectral image on the CMOS sensor 10. The spectral image is here called two-dimensional spectrum 26.

Combining the reflection and the diffraction makes it possible to extract almost all the intensity of the light beam. The echelle spectrometer has a very high luminosity, in other words, little loss.

The echelle spectrometer is for example based on an Aryelle 200 spectrometer from LTB, Lasertechnik Berlin GmbH, wherein the CCD sensor is replaced by a CMOS sensor, for example a sensor of the Prime BSI range from Teledyne.

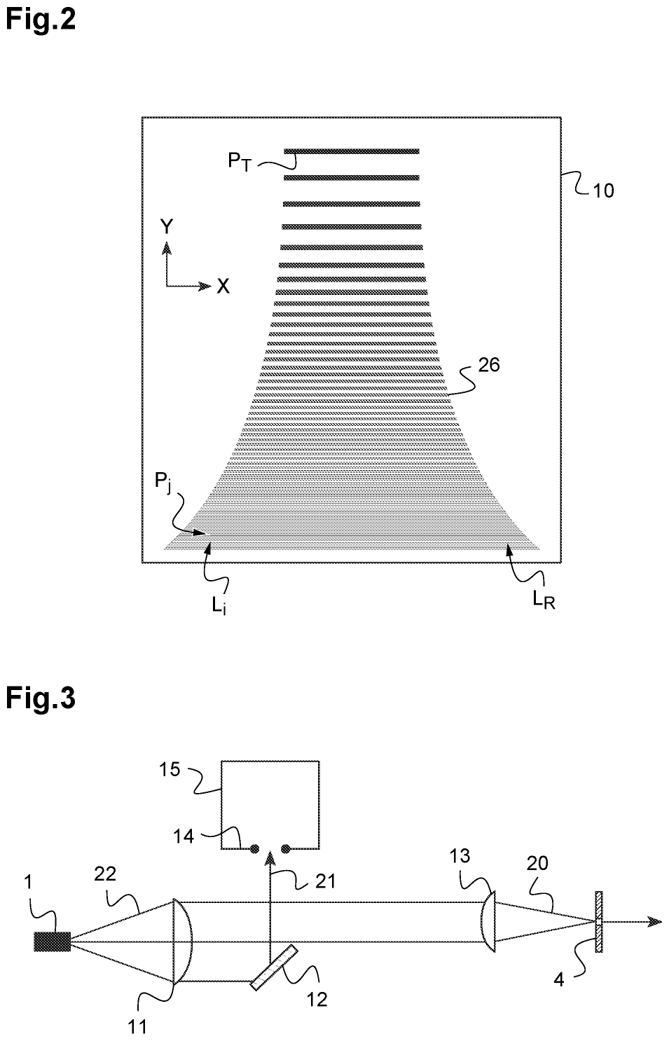

FIG. 2 schematically illustrates a two-dimensional spectrum 26 received on the CMOS sensor. The CMOS sensor is generally square-shaped. The CMOS sensor comprises for example 2048 rows and 2048 columns of pixels. For example, each pixel has an elementary size of 6.5 μm×6.5 μm. As an alternative, the received signals are cumulated on a macropixel, comprising for example 2×2 adjacent pixels in 2 rows and 2 columns. A macropixel extends over a surface area of about 13 μm×13 μm. This analysis per group of pixels (or “binning”) makes it possible to increase the sensitivity of the detected signal by a factor 4 without degrading the resolution of the Echelle+CMOS unit because, in the mounting used, the resolution-limiting factor is not the pixel size but the width of the input slit. This operating mode per group of pixels suits to a glow discharge source that has a low luminosity. There is little risk that such a source saturates the pixels of the CMOS sensor, including in macropixel mode.

The two-dimensional spectrum 26 is dispersed by the echelle grating according to the diffraction orders P₁, . . . Pⱼ, . . . P_{T} along the direction Y The CMOS sensor is directed in such a way that each diffraction order extends along a row of pixels. It is observed in FIG. 2 that the distance between the orders is not constant due to the dispersion of the prism. The lowest diffraction orders P₁ and P₂ are spaced apart by a distance lower than the distance between the highest diffraction orders P_{T-1} and P_{T}.

In each diffraction order, for example Pj, the one-dimensional spectrum is dispersed according to the wavelength along the direction X between a low wavelength Lᵢ and a high wavelength L_{R}. The echelle spectrometer combined with the CMOS sensor thus allows measuring simultaneously and rapidly the whole optical emission spectrum.

The diffraction efficiency of the echelle spectrometer is different according to the wavelength in each diffraction order. Such a signal processing system makes it possible to combine the different orders detected on the CMOS sensor to reconstruct a complete one-dimensional spectrum of the light beam as a function of the wavelength. The data flow generated by the CMOS sensor requires a particular processing system and/or algorithm to extract a complete spectrum as a function of time.

The speed of acquisition of the CMOS sensor makes it possible to acquire a two-dimensional spectrum with a temporal resolution of a few milliseconds, for example of 10 ms or 20 ms. This acquisition rate allows a temporal analysis of the GDS signals corresponding to a depth resolution for very thin layers, of nanometric thickness or of a few nanometers. The etching of a thin layer by the glow discharge plasma may be very rapid. In certain applications to thin layer analysis, a thin layer may be etched in a few milliseconds.

The currently available CMOS sensors are able to acquire the two-dimensional spectrum images at an acquisition rate of at least 20 frames per second, for example 30, 50 or even 100 frames per second. The images are transferred to a hard disk for later processing.

The echelle spectrometer has many advantages. It is compact and easy to couple to a glow discharge lamp. It has no movable part, which makes it very robust. The echelle spectrometer is generally calibrated in factory, for example using a mercury vapor lamp emitting light rays a very accurate wavelengths. It makes it possible to obtain, at each spectral image detected, a continuous spectrum over a very wide spectral range, for example from 203 nm to 800 nm. The optical resolution is not constant with an echelle spectrometer: for example, the spectral resolution obtained is approximately comparable to that of the GD polychromator, i.e. about 20-25 pm near 220 nm and about 50 pm in the red region. The absorption of the optical fiber 3 and the prism 7 limits the transmission in the UV region. In order to obtain results in the UV region, it is necessary to use an optical fiber that is transparent in the UV region or to couple directly the spectrometer to the discharge lamp. The detection of a continuous spectrum over a wide spectral range makes it possible to detect elements which are not expected a priori in the sample.

Thanks to its compactness, the echelle spectrometer combined with a CMOS sensor may be easily installed on an existing glow discharge spectrometry device.

The glow discharge spectrometry device based on an echelle spectrometer and a CMOS sensor finds many applications in the profile analysis of thin-layer samples. For example, the present disclosure may be applied to the analysis of hard disks formed of stacks of several thin layers, for example photovoltaic layers, electrolytic depositions or CVD or PVD depositions.

FIG. 3 shows an example of optical coupling system between a glow discharge lamp 2 and, on the one hand, the input 14 of a polychromator 15 and, on the other hand, the input 4 of the echelle spectrometer equipped with a CMOS sensor. A lens 11 collimates the light beam 22 emitted by the glow discharge plasma in the discharge lamp 1. A mirror 12 is placed on a half of the collimated light beam to deviate this half of the light beam 21 to the input of a polychromator. The other half of the light beam 20 propagates up to another lens 13 that focuses this other half of the light beam to the input 4 of the echelle spectrometer equipped with a CMOS sensor. Although the light flow is split in two on each sensing system, this optical coupling has many advantages.

Such an optical coupling system makes it possible to detect and follow simultaneously predetermined emission lines via the polychromator 15 equipped with photomultiplier sensors each including a slit, and on the other hand, the complete spectrum detected via the CMOS sensor 10 of the echelle spectrometer. In particular, the polychromator 15 makes it possible to follow emission lines in the ultraviolet region, which are more difficult to detect on the echelle spectrometer due to the presence of the prism 7. A polychromator also allows complex emission lines to be spectrally resolved. Advantageously, the electronic acquisition systems of the polychromator and the echelle spectrometer combined with the CMOS sensor are compatible with each other. For example, the polychromator provided with photomultiplier sensors is able the acquire emission lines at a rate between 1 Hz and 100 Hz. The data acquired by the two types of sensors, respectively PM and CMOS, are transferred to a computer processing system.

A hybrid glow discharge spectrometry device is thus obtained, with two types of sensor: PMs at the polychromator output and a CMOS imaging sensor at the echelle spectrometer output. The combination of these two sensing systems with the same glow discharge lamp makes it possible to acquire data in a synchronized manner and to benefit from the advantages of each sensing system. Advantageously, the speed of acquisition of the PMs is adjusted so as to be identical to that of the CMOS sensor. The PM and CMOS sensors are rapid, and thus allow a high temporal resolution. The polychromator, for example in Pashen-Runge mounting, provided with PMs, allows a detection up to the UV region, to follow emission lines at an accurately determined wavelength. The high-voltage loop control of each PM avoids saturation of the PM sensors. The PM sensors thus benefit from a very high measurement dynamics that may be adapted whatever the intensity of the detected signals. However, the number of PMs being limited and the position of each PM being fixed, the polychromator allows only certain pre-selected lines to be followed. The CMOS sensor has a more limited measurement dynamics than the PMs, but it allows acquiring a complete spectrum over a continuous and relatively extended spectral range, for example from 200 nm to 800 nm. That way, the CMOS sensor makes it possible to detect certain emission lines that were not foreseen in advance. Moreover, the CMOS sensor allows several lines associated with a same chemical element to be detected, which makes it possible to detect certain elements present as trace in the analyzed sample.

The hybrid glow discharge spectrometry device of the present disclosure finds new applications for the analysis of many solid materials and compounds. The polychromator makes it possible to follow lines in the ultraviolet region, which are more difficult to detect via the echelle spectrometer and the CMOS sensor. For example, the polychromator makes it possible to solve the optical emission lines of hydrogen and deuterium located around 120 nm, which are measured either sequentially, or by means of two slits placed in two different diffraction orders. The echelle spectrometer combined with the CMOS sensor does not allow reaching the far-UV region.

The glow discharge spectrometry device of the present disclosure is compatible with the use of an interferometer system of the differential interferometer type to measure the depth of the erosion crater in the sample during the exposure thereof to the etching plasma, as described in patent FR1453997.

Of course, various other modifications may be made to the invention within the scope of the appended claims.

1. A glow discharge spectrometry device (100) comprising a glow discharge lamp (1) adapted to form a glow discharge plasma (2) and an optical emission spectrometer adapted to receive part of a light beam (20) emitted by the glow discharge plasma, wherein the optical emission spectrometer comprises a dispersive optical component (7) and an echelle grating (8), the dispersive optical component (7) and the echelle grating (8) being arranged and configured to form a two-dimensional spectrum (26) of the light beam, the two-dimensional spectrum (26) being dispersed into a plurality of diffraction orders (P₁, . . . Pⱼ, . . . P_{T}), the plurality of diffraction orders (P₁, . . . Pⱼ, . . . P_{T}) extending along a first direction (X) and each diffraction order (P₁, . . . Pⱼ, . . . P_{T}) extending spectrally along a second direction (Y) transverse to the first direction (X), and pixel-array CMOS sensor (10) arranged and configured to acquire the two-dimensional spectrum (26) as a function of time.

2. The glow discharge spectrometry device (100) according to claim 1, wherein the CMOS sensor is adapted to acquire at least 20 frames per second.

3. The glow discharge spectrometry device (100) according to claim 1, wherein the CMOS sensor comprises N rows of M pixels, where N is higher than or equal to 512 and M is higher than or equal to 512.

4. The glow discharge spectrometry device (100) according to claim 1, wherein each diffraction order (P₁, . . . Pⱼ, . . . P_{T}) extends along a row of the CMOS sensor.

5. The glow discharge spectrometry device (100) according to claim 1, comprising a data processing system configured to process the CMOS sensor signals on a macropixel basis, each macropixel comprising at least 2×2 adjacent pixels of the CMOS sensor.

6. The glow discharge spectrometry device (100) according to claim 1, comprising an optical coupling system between the glow discharge lamp (1) and an input (4) of the optical emission spectrometer.

7. The glow discharge spectrometry device (100) according to claim 1, wherein the dispersive optical component (7) comprises a prism.

8. The glow discharge spectrometry device (100) according to claim 1, comprising a monochromator or a polychromator (15) adapted to receive another part of the light beam (21) emitted by the glow discharge plasma, the monochromator, respectively the polychromator (15), comprising a diffraction grating and a photomultiplier sensor, respectively several photomultiplier sensors, each photomultiplier sensor being adapted to detect an optical emission at a determined wavelength.

9. The glow discharge spectrometry device (100) according to claim 1, comprising a differential interferometer to measure an etching depth of an erosion crater in a sample exposed to the glow discharge plasma (2).

10. A glow discharge spectrometry method comprising the following steps:
forming a glow discharge plasma;
receiving part of a light beam (20) emitted by the glow discharge plasma at an input (4) of the optical emission spectrometer;
spectrally dispersing the part of the light beam over an echelle grating (8) and a dispersive optical component (7) to form a two-dimensional spectrum, the two-dimensional spectrum being dispersed into a plurality of diffraction orders (P₁, . . . Pⱼ, . . . P_{T}), the plurality of diffraction orders (P₁, . . . Pⱼ, . . . P_{T}) extending along a first direction (X) and each diffraction order (P₁, . . . Pⱼ, . . . P_{T}) extending spectrally along a direction transverse to the first direction; and
acquiring the two-dimensional spectrum on a pixel-array CMOS sensor as a function of time.

11. The glow discharge spectrometry device (100) according to claim 2, wherein the CMOS sensor comprises N rows of M pixels, where N is higher than or equal to 512 and M is higher than or equal to 512.

12. The glow discharge spectrometry device (100) according to claim 2, wherein each diffraction order (P₁, . . . Pⱼ, . . . P_{T}) extends along a row of the CMOS sensor.

13. The glow discharge spectrometry device (100) according to claim 3, wherein each diffraction order (P₁, . . . Pⱼ, . . . P_{T}) extends along a row of the CMOS sensor.

14. The glow discharge spectrometry device (100) according to claim 2, comprising a data processing system configured to process the CMOS sensor signals on a macropixel basis, each macropixel comprising at least 2×2 adjacent pixels of the CMOS sensor.

15. The glow discharge spectrometry device (100) according to claim 3, comprising a data processing system configured to process the CMOS sensor signals on a macropixel basis, each macropixel comprising at least 2×2 adjacent pixels of the CMOS sensor.

16. The glow discharge spectrometry device (100) according to claim 4, comprising a data processing system configured to process the CMOS sensor signals on a macropixel basis, each macropixel comprising at least 2×2 adjacent pixels of the CMOS sensor.

17. The glow discharge spectrometry device (100) according to claim 2, comprising an optical coupling system between the glow discharge lamp (1) and an input (4) of the optical emission spectrometer.

18. The glow discharge spectrometry device (100) according to claim 2, wherein the dispersive optical component (7) comprises a prism.

19. The glow discharge spectrometry device (100) according to claim 3, wherein the dispersive optical component (7) comprises a prism.

20. The glow discharge spectrometry device (100) according to claim 5, wherein the dispersive optical component (7) comprises a prism.
